(19) United States
(12) Patent Application Publication
(10) Pub. No.: US 2026/0189474 A1
(43) Pub. Date: Jul. 2, 2026

(54) COMMUNICATION METHOD, USER EQUIPMENT, AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/540,563

(22) Filed: Feb. 13, 2026

Related U.S. Application Data
(63) Continuation of application No. PCT/JP2024/028542, filed on Aug. 8, 2024.

(30) Foreign Application Priority Data
Aug. 14, 2023 (JP) 2023-132048

(51) Int. Cl. H04L 41/16; H04L 43/062

(52) U.S. Cl. CPC H04L 41/16; H04L 43/062

(57) ABSTRACT

A communication method performed by a user equipment in a mobile communication system includes a step of transmitting, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

### RELATED APPLICATIONS

The present application is a continuation based on PCT Application No. PCT/JP2024/028542, filed on Aug. 8, 2024, which claims the benefit of Japanese Patent Application No. 2023-132048 filed on Aug. 14, 2023. The content of which is incorporated by reference herein in their entirety.

### TECHNICAL FIELD

The present disclosure relates to a communication method, a user equipment, and a network node used in a mobile communication system.

### BACKGROUND

In the Third Generation Partnership Project (3GPP) (trade name; the same applies hereinafter), which is a standardization project for mobile communication systems, applying an artificial intelligence or machine learning (AI/ML) technology to wireless communication (air interface) in a mobile communication system has been studied.

### CITATION LIST

### Non-Patent Literature

Non-Patent Document 1: 3GPP Technical Report: TR 38.843 V 0.1.0 (2023-05), “Study on Artificial Intelligence (AI)/Machine Learning (ML) for NR air interface (Release 18)”

### SUMMARY

In a first aspect, a communication method is a method performed by a user equipment in a mobile communication system. The communication method includes a step of transmitting, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

In a second aspect, a user equipment is a user equipment to be used in a mobile communication system. The user equipment includes a transmitter configured to transmit, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

In a third aspect, a network node is a network node used in a mobile communication system. The network node includes a receiver configured to receive, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference from the user equipment.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (network node) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of an AI/ML technology in the mobile communication system according to an embodiment.

FIG. 7 is a diagram for describing an example of an operation scenario for the mobile communication system according to an embodiment.

FIG. 8 is a flowchart illustrating a first basic operation of the UE in the mobile communication system according to an embodiment.

FIG. 9 is a flowchart illustrating a second basic operation of the UE in the mobile communication system according to an embodiment.

FIG. 10 is a diagram illustrating a first operation pattern of the mobile communication system according to an embodiment.

FIG. 11 is a diagram illustrating a second operation pattern of the mobile communication system according to an embodiment.

FIG. 12 is a diagram illustrating an example of a third operation pattern of the mobile communication system according to an embodiment.

FIG. 13 is a diagram illustrating another example of the third operation pattern of the mobile communication system according to an embodiment.

FIG. 14 is a flowchart illustrating an operation example of the UE upon failing in a handover in a fourth operation pattern of the mobile communication system according to an embodiment.

FIG. 15 is a flowchart illustrating an operation example of the UE upon succeeding in a handover in the fourth operation pattern of the mobile communication system according to an embodiment.

FIG. 16 is a flowchart illustrating an example of a log transmission operation of the UE in the fourth operation pattern of the mobile communication system according to an embodiment.

### DESCRIPTION OF EMBODIMENTS

As a use case of the AI/ML technology, mobility control for a user equipment is conceivable. Specifically, the AI/ML technology is conceived to be applied to control of cell switching from a source cell to a target cell. However, a specific mechanism for applying the AI/ML technology to the mobility control for the user equipment has not been established yet, and the AI/ML technology is difficult to leverage in a mobile communication system.

The present disclosure provides enabling the AI/ML technology to be leveraged in the mobile communication system.

According to an embodiment, a mobile communication system is described with reference to the drawings. In the description of the drawings, the same or similar parts are denoted by the same or similar reference signs.

### (1) Configuration of Mobile Communication System

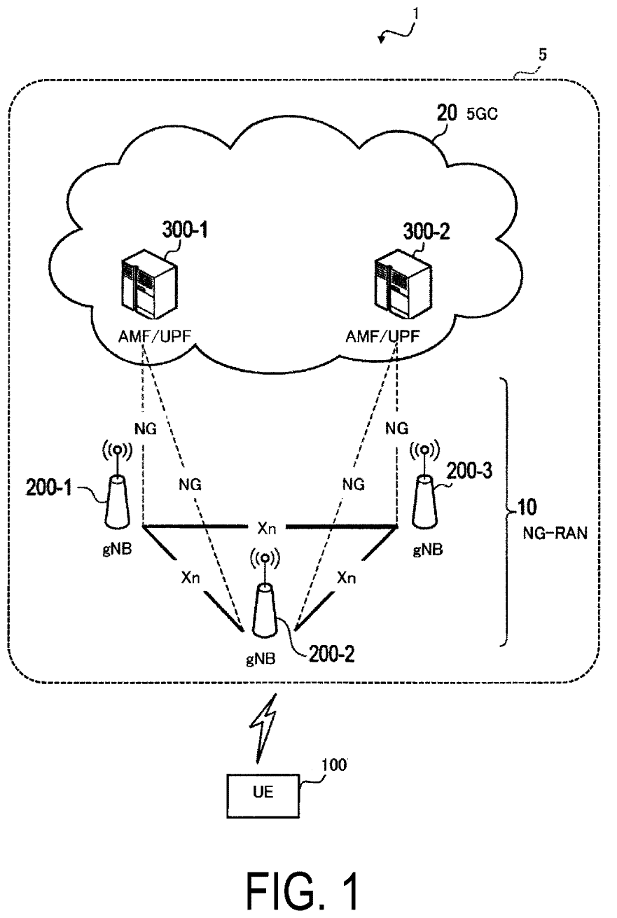

First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1. The UE 100 performs wireless communication with the network 5.

The UE 100 is a mobile wireless communication apparatus. The UE 100 may be any apparatus as long as the UE 100 is used by a user. Examples of the UE 100 include a mobile phone terminal (which may be a smartphone) or a tablet terminal, a notebook PC, a communication module (which may be a communication card or a chipset), a sensor or an apparatus provided on the sensor, a vehicle or an apparatus (Vehicle UE) provided on the vehicle, and a flying object or an apparatus (Aerial UE) provided on the flying object.

The NG-RAN 10 includes base stations 200 (referred to as “gNBs” in 5G systems), which are a type of network node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

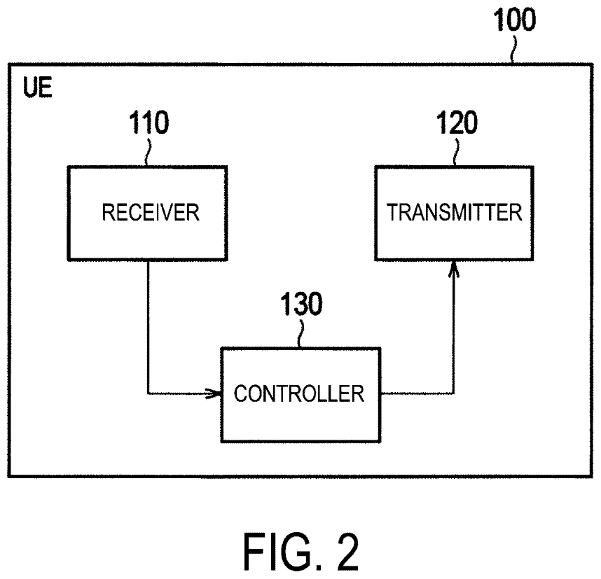

FIG. 2 is a diagram illustrating a configuration of the UE 100 (the user equipment) according to an embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. The operations of the UE 100 described above and to be described below may also be an operation under the control of the controller 130. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

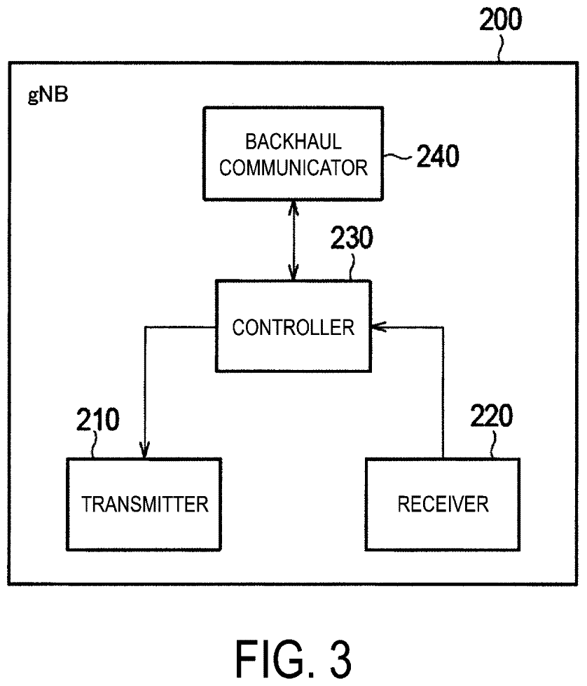

FIG. 3 is a diagram illustrating a configuration of the gNB 200 (network node) according to an embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. The operations of the gNB 200 described above and below may also be performed under the control of the controller 130. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a central unit (CU) and a distributed unit (DU) (i.e., functions are divided), and the two units may be connected via an F1 interface, which is a fronthaul interface.

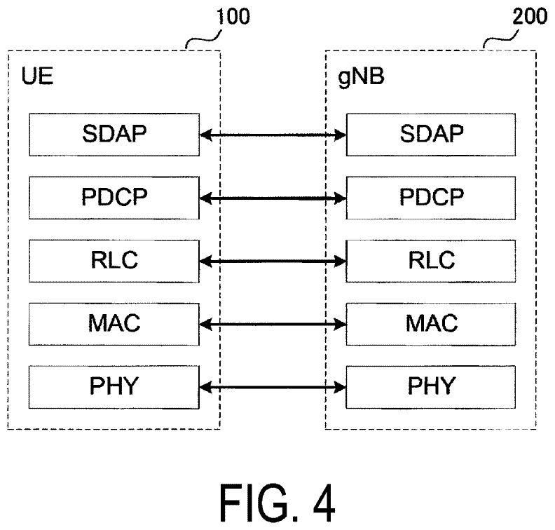

FIG. 4 is a diagram illustrating a configuration of a protocol stack of a radio interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

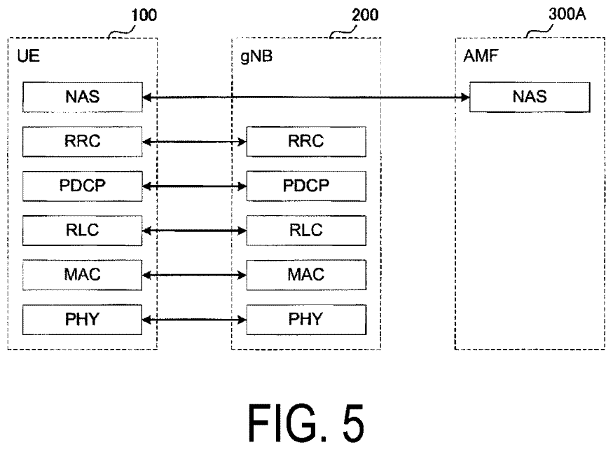

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300A. The UE 100 includes an application layer other than the protocol of the radio interface. A layer lower than the NAS is referred to as an Access Stratum (AS).

### (2) Overview of AI/ML Technology

An overview of the AI/ML technology is described. The mobile communication system 1 according to an embodiment applies the AI/ML technology to wireless communication (that is, an air interface).

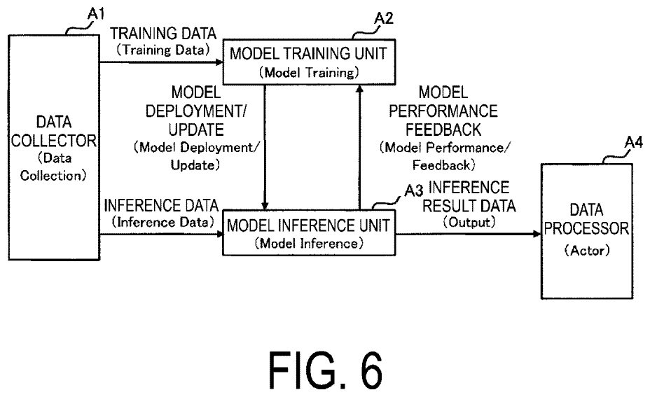

FIG. 6 is a diagram illustrating a functional block configuration of the AI/ML technology in the mobile communication system 1 according to an embodiment. The functional block configuration illustrated in FIG. 6 includes a data collector A1, a model training unit A2, a model inference unit A3, and a data processor A4.

The data collector A1 collects input data, specifically, training data and inference data, and outputs the training data to the model training unit A2 and outputs the inference data to the model inference unit A3. The data collector A1 may acquire data in the apparatus in which the data collector A1 is provided, as input data. The data collector A1 may acquire, as the input data, data in another apparatus.

The model training unit A2 performs model training (also referred to as “learning processing”). To be specific, the model training unit A2 optimizes parameters for the training model (hereinafter also referred to as a “model” or an “AI/ML model”) by machine learning using the training data, derives (generates or updates) a trained model, and outputs the trained model to the model inference unit A3. The model is data-driven algorithm in which a set of outputs is generated based on a set of inputs through application of the AI/ML technology. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score.

The model inference unit A3 performs model inference (also referred to as “inference processing”). To be specific, the model inference unit A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. Here, various techniques for the model are used, such as linear regression analysis, neural network, and decision tree analysis. The above “y=ax+b” can be considered as a kind of the linear regression analysis. The model inference unit A3 may perform model performance feedback to the model training unit A2.

The data processor A4 receives the inference result data and performs processing that utilizes the inference result data.

### (3) Operation of Mobile Communication System

In an embodiment, operations of the mobile communication system 1 are described. In the embodiment, the AI/ML technology is applied to the mobility control for the UE 100. Specifically, in the embodiment, the AI/ML technology is applied to cell switching from the source cell to the target cell, in particular, switching of the serving cell for the UE 100. As an example, the embodiment mainly describes a handover for switching a primary cell (PCell) for the UE 100 under initiative of an RRC layer when the UE 100 is in an RRC connected state.

The cell switching includes cell switching when the UE 100 is in the RRC connected state and cell switching when the UE 100 is in the RRC idle state or the RRC inactive state. Network 5-initiated control is applied to the cell switching when the UE 100 is in the RRC connected state. On the other hand, UE 100-initiated control is applied to the cell switching when the UE 100 is in the RRC idle state or the RRC inactive state. The cell switching when the UE 100 is in the RRC idle state or the RRC inactive state is referred to as cell reselection. Although the embodiment mainly describes an example of applying the AI/ML technology to the handover, the AI/ML technology may be applied to the cell reselection. In other words, the “handover” described below may be read as the “cell reselection”.

The cell switching when the UE 100 is in the RRC connected state includes, in addition to the handover, PSCell change for switching a primary-secondary cell (PSCell) for the UE 100 under initiative of the RRC layer, and an L1/L2 Triggered Mobility (LTM) which is cell switching under initiative of the layer 1 and/or the layer 2 (L1/L2). Although the embodiment mainly describes an example of applying the AI/ML technology to the handover, the AI/ML technology may be applied to the LTM or the PSCell change. In other words, the “handover” described below may be read as the “LTM” or the “PSCell change”. Note that in the LTM, for example, the gNB 200 configures one or more candidate cells for the UE 100 in advance in an RRC message, the UE 100 reports a cell measurement result to the gNB 200 in the L1, the gNB 200 instructs, to the UE 100, the cell switching to the target cell in a MAC control element (CE), and the UE 100 accesses the target cell in response to the instruction.

The handover includes a normal handover (also referred to as the “HO”) and a conditional handover (CHO). In the normal handover, the UE 100 transmits a Measurement Report message, which is a type of RRC message, to the gNB 200, the gNB 200 determines a target cell based on the Measurement Report message, the gNB 200 instructs to the UE 100 a handover to the target cell in the RRC message, and the UE 100 accesses the target cell in response to the instruction. In contrast, in the conditional handover, the gNB 200 configures one or more candidate cells together with an execution condition for handover for the UE 100 in advance in the RRC message, the UE 100 evaluates whether the execution condition for handover to any candidate cell is satisfied, and the UE 100 determines the candidate cell that the execution condition for handover is satisfied as a target cell and accesses the target cell. Note that a cell determined to be accessed by the UE 100 is referred to as a target cell, and a cell that is a candidate for the target cell is referred to as a candidate cell, but the terms “target cell” and “candidate cell” may be used as synonymous terms in the following description.

From the viewpoint of the network 5, the handover includes an intra-gNB (intra-CU) handover in which the source cell and the target cell belong to the same gNB (CU) and an inter-gNB (inter-CU) handover in which the source cell and the target cell belong to different gNBs (CUs). In the embodiments, the inter-gNB handover is mainly assumed, but the intra-gNB handover may also be assumed.

Further, the embodiment below mainly describes an example in which AI/ML-related signaling related to the AI/ML technology is an RRC message that is signaling of an RRC layer (that is, the layer 3). However, the AI/ML-related signaling may be a MAC CE that is signaling of a MAC layer signaling (that is, the layer 2). The AI/ML-related signaling may be downlink control information (DCI) and/or uplink control information (UCI) that are/is signaling of a PHY layer signaling (that is, the L1). The downlink AI/ML-related signaling may be UE individual signaling (dedicated signaling). The downlink AI/ML-related signaling may be broadcast signaling (e.g., system information block (SIB)). The AI/ML-related signaling may be signaling in a new layer (e.g., an AI/ML layer) dedicated to artificial intelligence or machine learning.

### (3.1) Operation Scenario of Mobile Communication System

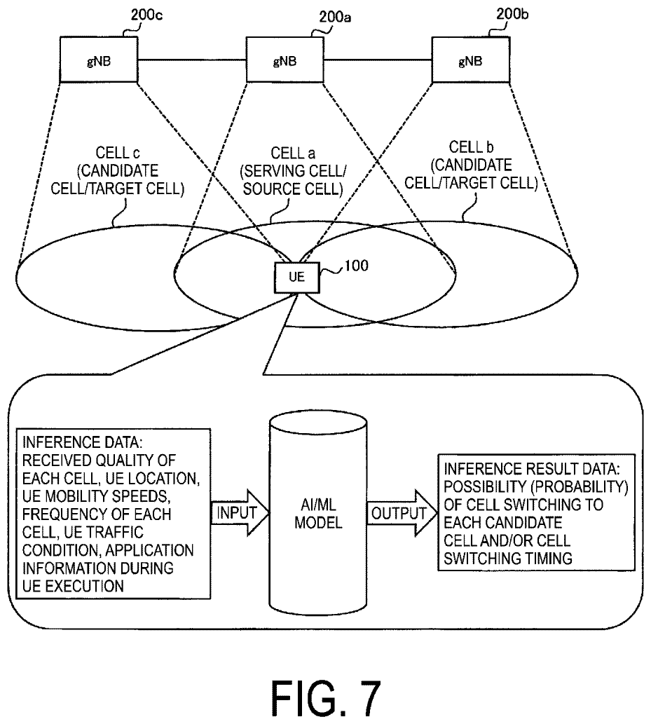

FIG. 7 is a diagram for describing an example of an operation scenario for the mobile communication system 1 according to the embodiment.

In the illustrated example, the UE 100 is in the RRC connected state with a cell a managed by a gNB 200a being the serving cell. In other words, the UE 100 establishes an RRC connection to the gNB 200a and is in wireless communication with the gNB 200a. Neighboring cells of the cell a include cells b and c. The cell b is managed by a gNB 200b, and the cell c is managed by a gNB 200c. The gNB 200a is communicably connected to the gNB 200b and the gNB 200b via an inter-node interface (Xn interface).

In response to the UE 100 moving, the handover of the UE 100 needs to be executed from the cell a to the neighboring cell. In the illustrated example, the neighboring cells are cell b and cell c, and the cells b and c are candidate cells for handover.

For the normal handover, the UE 100 transmits a Measurement Report message, which is a type of RRC message, to the gNB 200, the gNB 200 determines any one of the cells b and c as a target cell based on the Measurement Report message, the gNB 200 instructs to the UE 100 a handover to the target cell in the RRC message, and the UE 100 accesses the target cell in response to the instruction.

For the conditional handover, the gNB 200 configures one or more candidate cells (cells b and c) together with an execution condition for handover for the UE 100 in advance in the RRC message, the UE 100 evaluates whether the execution condition for handover to any candidate cell is satisfied, and the UE 100 determines the candidate cell that the execution condition for handover is satisfied as a target cell and accesses the target cell.

In such a handover, for example, the following problem may occur.
Too early handover:
   Since the HO execution is too early, the UE 100 may fail to access the target cell.
Too late handover:
   Since the HO execution is too late, a radio link failure (RLF) may occur between the UE 100 and the source cell.
Handover to wrong cell:
   Since the HO of the UE 100 is executed to a cell different from a cell to which the HO is originally to be executed, a ping-pong phenomenon occurs in which the HO needs to be immediately r-executed.

In the embodiment, the AI/ML technology is applied to the handover of the UE 100, and such a problem can be solved. To be more specific, an AI/ML model for handover is deployed in the UE 100, and the UE 100 determines a candidate cell (target cell) and/or determines an execution timing of handover to the target cell by model inference by using the AI/ML model (trained model). This makes it possible to optimize the determination of the target cell and/or the execution timing of the handover, and the handover problem as described above may be solved.

Note that in the embodiment, the UE 100 uses, as the inference data to be input to the AI/ML model, at least one selected from the group consisting of a radio quality (measured value) of each cell, a UE location (measured location), a UE mobility speeds, a frequency of each cell, a UE traffic condition, and application information during UE execution. The inference data may include cell IDs of the respective cells.

Here, the radio quality may be at least one selected from the group consisting of reference signal received power (RSRP), reference signal radio quality (RSRQ), signal-to-interference-plus-noise ratio (SINR), bit error rate (BER), block error rate (BLER), and analog-to-digital converter output waveform. The radio quality may be time series data including a plurality of measurement values in a past certain period. The UE location is geographic position information obtained by the UE 100 by using a global navigation satellite system (GNSS) receiver and/or a positioning reference signal, and may be a combination of latitude and longitude. The UE location may be a combination of latitude, longitude, and altitude. The UE mobility speed may be a UE acceleration. The UE mobility speed may be a UE mobility state (stationary state, low-speed mobility state, a high-speed mobility state, or the like). The frequency of each cell may be a band to which the cell belongs. The frequency may be a frequency range (FR). The UE traffic condition may be a traffic amount or a traffic pattern generated in the UE 100. The application information during UE execution may be information of required quality of service (QoS).

The inference data to be input to the AI/ML model may include at least one selected from the group consisting of a bandwidth of each cell, a cell size (or transmit power) of each cell, and a radio parameter of each cell. These pieces of inference data may be acquired from system information (broadcast signaling) of each cell. The radio parameter may be, for example, a random access channel (RACH) parameter, a cell reselection parameter (e.g., frequency priority and/or cell minimum quality (S-criterion)), or other radio parameters.

Here, by using the bandwidth as the inference data, an expectable throughput (service quality) can be estimated. Therefore, for example, mobility control is facilitated such as preferentially selecting a candidate cell having a system bandwidth equivalent to that of the current serving cell. By using the cell size (transmit power of the cell) as the inference data, a large cell can be prioritized over a small cell in order to increase the HO success rate, or the small cell is prioritized (in low-speed mobility) or the large cell is prioritized (in high-speed mobility) according to the UE mobility speed. The cell size may be estimated from, for example, an uplink maximum transmission power configuration. By using the RACH parameter as the inference data, a HO success probability can be increased because physical random access channel (PRACH) collision is less in the large (wide) RACH resource, particularly when performing contention-based random access (CBRA). By using the cell reselection parameter as the inference data, a cell with a little traffic (that is, a cell with a low priority) can be intentionally selected based on the frequency priority, or the cell size can be estimated based on the S-criterion.

In the embodiment, the inference result data output by the AI/ML model is information indicating the possibility of the cell switching to each candidate cell and/or information indicating the cell switching timing. The information indicating the possibility of the cell switching may be a probability value of the cell switching to each candidate cell. The information indicating the cell switching timing may be a relative value indicating how many ms later the handover is to be executed (access to the target cell) with reference to the current time. The information may be an absolute value indicating the timing at which the handover is to be executed (to access the target cell).

Such an AI/ML model may be held in advance by the UE 100 before the model inference. Such an AI/ML model may be provided to the UE 100 by the gNB 200 before the model inference.

### (3.2) Overview of Operation of Mobile Communication System

In the embodiment, an overview of the operations of the mobile communication system 1 is described.

### (3.2.1) First Basic Operation

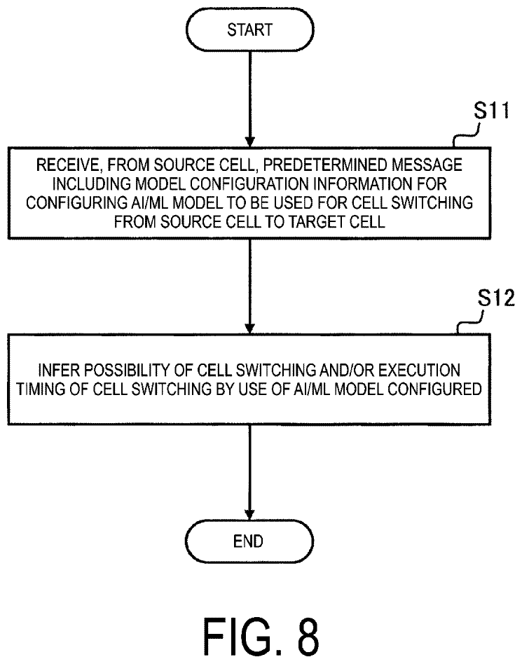

FIG. 8 is a flowchart illustrating a first basic operation of the UE 100 in the mobile communication system 1 according to the embodiment.

In step S11, the UE 100 receives a predetermined message from the source cell (gNB 200), the predetermined message including model configuration information for configuring (designating) an AI/ML model to be used for the cell switching (handover, in the embodiment) from the source cell to the target cell.

In step S12, the UE 100 infers the possibility of the handover and/or the execution timing of the handover by using the AI/ML model configured in step S11. Note that, in the following description, the term “infer” may be used as a term meaning “estimate”, “evaluate”, “determine”, or “decide”, but these terms may be interchangeable.

According to the first basic operation like this, the AI/ML technology is applied to the handover of the UE 100, and the problem in the handover as described above can be solved. To be more specific, the AI/ML model for handover is configured for the UE 100, and the UE 100 can determine the candidate cell (target cell) and/or determine the execution timing of the handover to the target cell by the model inference by using the AI/ML model. This makes it possible to optimize the determination of the target cell and/or the execution timing of handover. Since the gNB 200 configures the AI/ML model for handover for the UE 100, the handover principles of the network 5-initiated control can be maintained.

The UE 100 that performs such an operation includes the receiver 110 configured to receive a predetermined message from the source cell, the predetermined message including model configuration information for configuring an AI/ML model to be used for handover, and the controller 130 configured to infer the possibility of the handover and/or the execution timing of the handover by using the AI/ML model configured. On the other hand, the gNB 200 includes the transmitter 210 configured to transmits a predetermined message to the UE 100, the predetermined message including model configuration information for configuring an AI/ML model to be used for handover.

In the first basic operation, the model configuration information may include identification information for identifying the AI/ML model for handover (also referred to as “model identification information”). In this case, the UE 100 may hold the AI/ML model for handover in advance. The model identification information may be a function ID indicating a function of the AI/ML model. The model identification information may be a model ID uniquely identifying the AI/ML model.

Note that the AI/ML model for inferring the possibility of the handover and the AI/ML model for inferring the execution timing of the handover may be the same AI/ML model. These AI/ML models may be different AI/ML models. In the former case, a function ID of “inference of possibility of handover” and a function ID of “inference of execution timing of handover” may be separately defined. In the latter case, the function ID may be a function ID of “handover control”.

In the first basic operation, the model configuration information may include the AI/ML model for handover. In other words, the gNB 200 may provide the UE 100 with the AI/ML model for handover itself. In this case, the UE 100 does not need to hold the AI/ML model for handover in advance. The AI/ML model provided by the gNB 200 may be assigned with the model identification information. For the AI/ML model provided by the gNB 200, the AI/ML model for inferring the possibility of the handover and the AI/ML model for inferring the execution timing of the handover may be the same AI/ML model. These AI/ML models may be different AI/ML models.

In the first basic operation, the predetermined message including the model configuration information may be an RRC Reconfiguration message. The RRC Reconfiguration message may be any one of 1) an RRC Reconfiguration message for instructing execution of a handover, 2) an RRC Reconfiguration message for configuring measurements for handover, and 3) an RRC Reconfiguration message for configuring conditional handover for the UE 100.

The RRC Reconfiguration message for configuring the conditional handover for the UE 100 includes Conditional Reconfiguration information for configuring the conditional handover. The Conditional Reconfiguration information may include the model configuration information.

In the first basic operation, the UE 100 may receive an instruction message (handover command) instructing execution of the handover from the source cell (the gNB 200 managing the source cell). The UE 100 may receive the predetermined message including the model configuration information from the source cell before receiving the instruction message from the source cell. Such a predetermined message may be an RRC Reconfiguration message including measurement configuration information for configuring measurements for handover and model configuration information.

### (3.2.2) Second Basic Operation

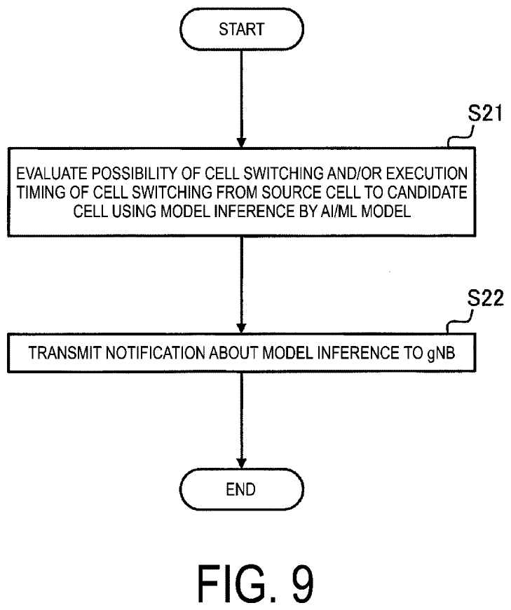

FIG. 9 is a flowchart illustrating a second basic operation of the UE 100 in the mobile communication system 1 according to the embodiment. The second basic operation may be implemented in combination with the first basic operation.

In step S21, the UE 100 evaluates the possibility of the handover and/or the execution timing of the handover using the model inference by the AI/ML model.

In step S22, the UE 100 transmits a notification (report) about the model inference to the gNB 200 based on the model inference in step S21.

According to the second basic operation like this, the AI/ML technology is applied to the handover of the UE 100, and the problem in the handover as described above can be solved. To be more specific, by transmitting the notification about the model inference for evaluating (inferring) the possibility of the handover and/or the execution timing of the handover from the UE 100 to the gNB 200, the gNB 200 can grasp the status of the model inference in the UE 100. As a result, the gNB 200 (network 5) can prepare for the handover of the UE 100 and perform autonomous optimization in the network 5.

The UE 100 that performs such an operation includes the transmitter 120 configured to transmit a notification about the model inference to gNB 200 based on an evaluation of the possibility of the handover and/or the execution timing of the handover that is performed by the UE 100 using the model inference by the AI/ML model. On the other hand, the gNB 200 includes the receiver 220 configured to receive the notification about the model inference from the UE 100 based on an evaluation of the possibility of the handover and/or the execution timing of the handover that is performed by the UE 100 using the model inference by the AI/ML model.

In the second basic operation, the notification (report) in step S22 may include information indicating the inference result of the model inference in step S21 and the identification information of the candidate cell (for example, cell ID). The notification (report) in step S22 report may include at least one kind of information of the model identification information (model ID and/or functional ID), information indicating the possibility of the cell switching in the model inference result data, and information indicating the switching timing in the model inference result data. The notification (report) in step S22 report may include the radio quality information of the serving cell and the candidate cell and/or the UE location information. In step S22, the UE 100 may transmit the notification to the gNB 200 managing the source cell. This allows the gNB 200 managing the source cell to grasp the possibility of the handover to the candidate cell and/or the execution timing of the handover, and appropriately perform the handover preparation of the UE 100.

In the second basic operation, after attempting a handover (access to the target cell), the UE 100 may store log information regarding whether the handover was successful. The log information is failure log information indicating that the handover was failed or success log information indicating that the handover was succeeded. The log information may include model inference information regarding whether the model inference was applied to the handover. The UE 100, in step S22, may transmit a notification including the log information to the gNB 200. This allows the gNB 200 (network 5) to perform autonomous optimization in the network 5 (for example, optimize the AI/ML model to be provided to the UE 100 in the future) using the log information.

Here, the model inference information may include identification information (function ID or model ID) for identifying the AI/ML model that was used for the model inference. The model inference information may include information indicating that the model inference was applied to the handover. The model inference information may include information indicating the result of the model inference.

### (3.3) Specific Example of Operation of Mobile Communication System

In the embodiment, first to fourth operation patterns are described as specific examples of the operations of the mobile communication system 1.

### (3.3.1) First Operation Pattern of Mobile Communication System

The first operation pattern is an operation pattern to apply the AI/ML technology to a normal handover that is not a conditional handover. In the first operation pattern, the timing (execution timing of handover) at which the UE 100 having received the handover command accesses the target cell is optimized by the model inference.

In the first operation pattern, the UE 100 receives a predetermined message including the model configuration information from the source cell (gNB 200) before receiving the instruction message (handover command) instructing execution of handover from the source cell. In other words, the gNB 200 (source cell) configures the AI/ML model for handover for the UE 100 before transmitting the handover command. This allows the UE 100 to start the model inference to evaluate and determine the execution timing of the handover before receiving the handover command. Therefore, the UE 100 can complete the model inference by the time of receiving the handover command, and adjust the timing of starting access to the target cell.

In the first operation pattern, the predetermined message including the model configuration information may be an RRC Reconfiguration message for configuring measurements for handover. The RRC Reconfiguration message may include the Measurement Configuration information and the model configuration information. In other words, the AI/ML model for adjusting the execution timing of the handover may be configured for the UE 100 simultaneously with the measurement configuration in the RRC Reconfiguration message. This makes it possible to efficiently configure the AI/ML model for adjusting the execution timing of the handover for the UE 100 at an appropriate timing.

In the first operation pattern, the UE 100 may prepare for the starting the inference processing (model inference) by the AI/ML model based on the model configuration information in response to receiving the predetermined message including the model configuration information. The UE 100 may start the model inference in response to the first condition related to the radio quality being satisfied after the receiving the predetermined message. In other words, the AI/ML model for adjusting the execution timing of the handover may be deployed in the UE 100 at the time of configuring the AI/ML model, and may be activated (executed) when a certain condition (first condition) is satisfied. This makes it possible to suppress an increase in processing load required for the model inference, compared to starting the model inference immediately after receiving the predetermined message.

Here, the first condition may be a condition related to the radio quality of the neighboring cell (candidate cell) becoming relatively higher than the radio quality of the serving cell (source cell). For example, the first condition may be any one of the radio quality of the serving cell becoming equal to or less than a threshold, the radio quality of the neighboring cell becoming equal to or more than a threshold, and a difference between the radio quality of the serving cell and the radio quality (+offset) of the neighboring cell becoming equal to or less than a threshold.

After starting the model inference, the UE 100 may deactivate (stop) the model inference in response to the second condition related to the radio quality being satisfied. The second condition may be a condition related to the radio quality of the neighboring cell (candidate cell) becoming relatively lower than the radio quality of the serving cell (source cell). For example, the second condition may be any one of the radio quality of the serving cell exceeding a threshold, the radio quality of the neighboring cell becoming less than a threshold, and the difference between the radio quality of the serving cell and the radio quality (+offset) of the neighboring cell exceeding a threshold.

The first condition and/or the second condition may be configured as a part of the model configuration information by the gNB 200 for the UE 100. For example, the gNB 200 may configure the thresholds used to determine the first condition and/or the second condition for the UE 100 in an RRC Reconfiguration message.

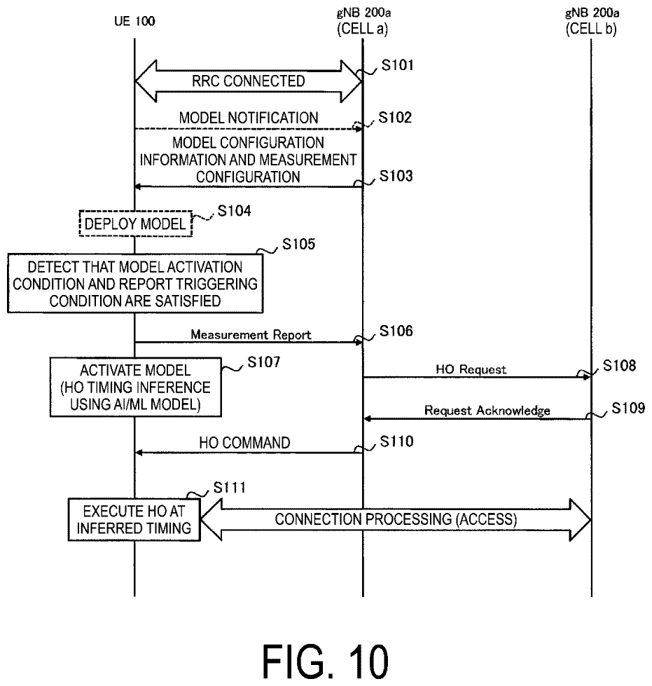

FIG. 10 is a diagram illustrating the first operation pattern of the mobile communication system 1 according to the embodiment.

In step S101, the UE 100 is in the RRC connected state with the cell a managed by the gNB 200a being the serving cell.

In step S102, the UE 100 may transmit, to the cell a (gNB 200a), a model notification including the identification information (function ID or model ID) of the AI/ML model that the UE 100 has. The UE 100 may transmit, to the cell a (gNB 200a), a UE Capability Information message, which is a type of RRC message indicating capabilities of the UE 100 and including the model notification. The model notification may be registered and held in the gNB 200 (network 5) as part of a UE context.

In step S103, the gNB 200a transmits an RRC Reconfiguration message including the model configuration information for optimizing the execution timing of the handover to the UE 100. The UE 100 receives the RRC Reconfiguration message. After receiving the RRC Reconfiguration message, the UE 100 may transmit an RRC Reconfiguration Complete message to the gNB 200a.

Here, the model configuration information includes at least one piece of information of the following 1) to 4).
1) Identification information of the AI/ML model (model ID or function ID):
   The model ID may be an identifier uniquely identifying the AI/ML model for adjusting the execution timing of the handover. The function ID may be, for example, an identifier indicating a function of adjusting (inferring) the execution timing of the handover. Note that the UE 100, when not having the AI/ML model designated by the gNB 200a, may transmit a model provision request to the gNB 200a. The model provision request may include the identification information (model ID or function ID) of the AI/ML model requested to be provided. The gNB 200a may respond to the request and provide the AI/ML model to the UE 100.
2) AI/ML model:
   The gNB 200 may provide the AI/ML model itself for optimizing the execution timing of the handover to the UE 100.
3) Condition configuration information for configuring the condition (first condition) for activating/the condition (second condition) for deactivating the model inference by the AI/ML model:
   The condition configuration information may be information equivalent to an event trigger configuration of the Measurement Report message. For example, the condition configuration information may include information indicating a type of an event for activating the AI/ML model and a threshold for defining the event. The event type may be, for example, any one of Event A1 (Serving becomes better than threshold), Event A2 (Serving becomes worse than threshold), and Event A3 (Neighbour becomes amount of offset better than PCell/PSCell).
4) Time-to-trigger (TTT) configuration information:
   TTT indicates the time from when the configured event is satisfied until the AI/ML model is activated.
The RRC Reconfiguration message in step S103 may include the Measurement Configuration. In other words, the configuration of the AI/ML model (model inference) and the measurement configuration may be performed at the same time. The configuration of the AI/ML model (model inference) may be configured as part of the measurement configuration. In this case, in the measurement configuration, an AI/ML model may be designated (for example, a model ID may be configured) for each report configuration (event trigger configuration of the Measurement Report message). Triggering of activation of the model inference and transmission triggering of the Measurement Report message may be performed on the basis of the same event trigger configuration. In this case, when a transmission triggering condition of the Measurement Report message is satisfied, the UE 100 triggers transmission of the Measurement Report message and triggers activation of the model inference.

In step S104, the UE 100 may deploy the AI/ML model in accordance with the model configuration information of step S103. Specifically, the UE 100 may deploy the AI/ML model in an AI processor of the UE 100 to prepare for execution of the AI/ML model.

In step S105, the UE 100 detects that the first condition for activating the configured AI/ML model is satisfied. The UE 100 also detects that the transmission triggering condition (report triggering condition) of the Measurement Report message is satisfied. When the report triggering condition and the first condition are made common, the UE 100 may detect that the common condition is satisfied.

In step S106, the UE 100 transmits the Measurement Report message to the cell a (gNB 200a). The Measurement Report message includes the measurement result of the radio quality of each cell.

In step S107, the UE 100 activates the configured AI/ML model and starts evaluating (estimating) the optimal timing to execute the handover using the model inference by the AI/ML model. Note that step S107 may be performed at the same time as step S106. The UE 100 evaluates the execution timing (optimal timing) of the handover for each candidate cell (e.g., the cell b and the cell c) by using the activated AI/ML model. Here, the UE 100 may evaluate (estimate) a cell having a possibility of a handover by using the activated AI/ML model, and identify the cell having a possibility of a handover as a candidate cell.

On the other hand, in step S108, the gNB 200a determines a target cell of a handover of the UE 100 based on the Measurement Report message of step S106. Here, assume that the cell b is determined to be the target cell. The gNB 200a transmits a HO Request message for requesting a handover of the UE 100 to the gNB 200b managing the cell b.

In step S109, the gNB 200b transmits a HO Request Acknowledge message to the gNB 200a in response to receiving the HO Request message. The HO Request Acknowledge message includes configuration information (RRC configuration information) required for the UE 100 to access the target cell (cell b).

In step S110, in response to receiving the HO Request Acknowledge message, the gNB 200a transmits an RRC Reconfiguration message, as a HO command, including the RRC configuration information in the HO Request Acknowledge message to the UE 100. The UE 100 receives the HO command. Note that since the gNB 200 configures the handover timing optimization by the model inference for the UE 100, a transmission timing of the HO command is desirably slightly earlier than the conventional handover command transmission timing. This facilitates preventing Too late handover by the model inference.

In step S111, the UE 100 starts access (connection processing) to the cell b, which is the target cell, at the optimal timing derived by the HO timing inference using the AI/ML model. The UE 100 may initiate the random access procedure for the cell b at the optimal timing, and transmit the random access preamble to the cell b. Alternatively, when the random access procedure is omitted, the UE 100 may transmit an RRC Reconfiguration Complete message to the cell b at the optimal timing. When such connection processing is completed, the UE 100 continues communication with the cell b being a new serving cell.

### (3.3.2) Second Operation Pattern of Mobile Communication System

The second operation pattern is an operation pattern to apply the AI/ML technology to the conditional handover.

In the second operation pattern, the UE 100 evaluates whether the execution condition for handover to the candidate cell is satisfied (trigger evaluation) using the model inference by the AI/ML model. The gNB 200 configures (designates) the AI/ML as part of the conditional handover configuration. To be more specific, the gNB 200 transmits the model configuration information for configuring (designating) the AI/ML model to the UE 100 in an RRC Reconfiguration message for configuring the conditional handover for the UE 100.

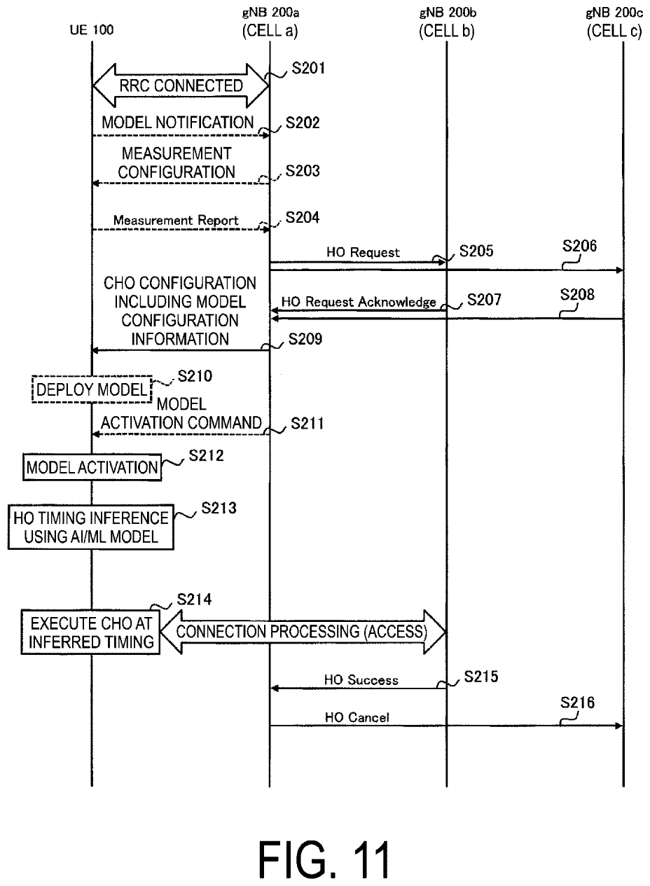

FIG. 11 is a diagram illustrating the second operation pattern of the mobile communication system 1 according to the embodiment.

In step S201, the UE 100 is in the RRC connected state with the cell a managed by the gNB 200a being the serving cell.

In step S202, the UE 100 may transmit, to the cell a (gNB 200a), a model notification including the identification information (function ID or model ID) of the AI/ML model that the UE 100 has. The UE 100 may transmit, to the cell a (gNB 200a), a UE Capability Information message, which is a type of RRC message indicating capabilities of the UE 100 and including the model notification. The model notification may be registered and held in the gNB 200 (network 5) as part of a UE context.

In step S203, the gNB 200a may transmit an RRC Reconfiguration message including the Measurement Configuration to the UE 100. The UE 100 receives the RRC Reconfiguration message. After receiving the RRC Reconfiguration message, the UE 100 may transmit an RRC Reconfiguration Complete message to the gNB 200a.

In step S204, the UE 100 may transmit a Measurement Report message to the gNB 200a in accordance with the measurement configuration of step S203. The gNB 200 receives the Measurement Report message.

In step S205, the gNB 200a determines the cells b and c as candidate cells, and transmits a HO Request message for requesting a conditional handover of the UE 100 to the gNB 200b managing the cell b.

In step S206, the gNB 200a transmits a HO Request message for requesting a conditional handover of the UE 100 to the gNB 200c managing the cell c.

In step S207, the gNB 200b transmits a HO Request Acknowledge message to the gNB 200a in response to receiving the HO Request message. The HO Request Acknowledge message includes configuration information (RRC configuration information) required for the UE 100 to access the cell b.

In step S208, the gNB 200c transmits a HO Request Acknowledge message to the gNB 200a in response to receiving the HO Request message. The HO Request Acknowledge message includes configuration information (RRC configuration information) required for the UE 100 to access the cell c.

In step S209, the gNB 200a configures a model inference-based conditional handover (CHO) for the UE 100. To be more specific, in response to receiving the HO Request Acknowledge messages of the steps S207 and S208, the gNB 200a transmits to the UE 100 an RRC Reconfiguration message including the RRC configuration information included in these HO Request Acknowledge messages as Conditional Reconfiguration information. The UE 100 receives the RRC Reconfiguration message. After receiving the RRC Reconfiguration message, the UE 100 may transmit an RRC Reconfiguration Complete message to the gNB 200a.

Here, the conditional reconfiguration information may include the cell ID and RRC configuration information for each of the candidate cells (cell b and cell c).

In the second operation pattern, the conditional reconfiguration information includes the model configuration information for configuring (designating) an AI/ML model to be used to evaluate a handover execution trigger. The model configuration information includes at least one piece of information of the following 1) to 5). The model configuration information may include such information as information independent for each candidate cell. The model configuration information may include that information as information common to all candidate cells.
1) Identification information of the AI/ML model to be used to evaluate the handover execution trigger (model ID or function ID):
   The model ID may be an identifier uniquely identifying the AI/ML model to be used to evaluate the trigger of the conditional handover. The function ID may be, for example, an identifier indicating a function of evaluating the trigger of the conditional handover. Note that the UE 100, when not having the AI/ML model designated by the gNB 200a, may transmit a model provision request to the gNB 200a. The model provision request may include the identification information (model ID or function ID) of the AI/ML model requested to be provided. The gNB 200a may respond to the request and provide the AI/ML model to the UE 100.
2) AI/ML model:
   The gNB 200 may provide the AI/ML model itself to be used to evaluate the handover execution trigger to the UE 100.
3) Information indicating the “model inference” as event type information in the execution condition for handover (triggering condition):
   Information indicating the “model inference” (which may be a model ID) may be included as the “CHO execution condition” for configuring the execution condition for handover.
4) Restriction information for trigger evaluation:
   The restriction information may include information (e.g., a threshold) indicating a radio quality range in which triggering of a conditional handover is permitted on a model inference basis. The restriction information may include a radio quality threshold that forcibly triggers a conditional handover.
5) Model activation information:
   The model activation information is configuration information indicating whether to activate the AI/ML model (model inference) at the time of configuring the AI/ML model. After the AI/ML model is configured, the AI/ML model (model inference) may be activated by the gNB 200 transmitting a model activation command to the UE 100.

In step S210, the UE 100 may deploy the AI/ML model in accordance with the model configuration information of step S209. Specifically, the UE 100 may deploy the AI/ML model in an AI processor of the UE 100 to prepare for execution of the AI/ML model.

In step S211, the gNB 200 may transmit a model activation command to the UE 100. The model activation command may include the identification information (model ID or function ID) of the AI/ML model to be activated. The model activation command may be, for example, an RRC message. The model activation command may be, for example, a MAC CE.

In step S212, the UE 100 activates the AI/ML model and starts evaluating the optimal HO execution timing (CHO trigger) for each candidate cell. Note that, when the model activation information indicates that the AI/ML model (model inference) is activated at the time of configuring the AI/ML model, the UE 100 may activate the AI/ML model (model inference) at the time of configuring the AI/ML model (step S209) or at the time of deploying the AI/ML model (step S210).

In step S213, the UE 100 inputs at least the measurement result of the radio quality of each cell to the AI/ML model, and determines the execution timing of the conditional handover (trigger) using the model inference by the AI/ML model. The AI/ML model may output the optimal HO execution timing (access timing) for each candidate cell. When there are a plurality of candidate cells, the UE 100 may determine a candidate cell having the earliest optimal HO execution timing as the target cell and access the target cell. The AI/ML model may output information indicating that the optimal HO execution timing has arrived (indicating that the HO execution should be triggered) for each candidate cell. Here, assume that the cell b among the candidate cells (cells b and c) is determined to be the target cell.

In step S214, the UE 100 executes a handover to the target cell (cell b) at the timing determined at step S213 and starts accessing the target cell. The UE 100 may initiate the random access procedure for the cell b at that timing, and transmit the random access preamble to the cell b. Alternatively, when the random access procedure is omitted, the UE 100 may transmit an RRC Reconfiguration Complete message to the cell b at the optimal timing. When such connection processing is completed, the UE 100 continues communication with the cell b being a new serving cell.

In step S215, the gNB 200b, which is the target gNB, transmits a HO Success message indicating that the UE 100 has successfully accessed the target cell (cell b) to the gNB 200a, which is the source gNB.

In step S216, the gNB 200a transmits a HO Cancel message indicating cancellation of the conditional handover of the UE 100 to the gNB 200c.

### (3.3.3) Third Operation Pattern of Mobile Communication System

The third operation pattern is an operation pattern to apply the AI/ML technology to an enhanced conditional handover. In the third operation pattern, the UE 100 performs the following two evaluations using the model inference by the AI/ML model:
1) Evaluation of a possibility of a handover;
2) Evaluation of an execution timing of a handover.

The third operation pattern is common to the second operation pattern in that the execution timing of the handover is evaluated using the model inference. However, in the second operation pattern, in step S204, the UE 100 may need to transmit a Measurement Report message to the gNB 200a. In this case, the gNB 200a may determine many cells as candidate cells based on the Measurement Report message. Since only one cell is basically determined to be the target cell among the candidate cells, resource efficiency may be reduced due to many cells as the candidate cells. In addition, when a long time has elapsed after the transmission of the Measurement Report message by the UE 100 until the CHO condition is satisfied and the UE 100 accesses the target cell, the resources are required to be prepared (reserved) for the UE 100 in each candidate cell for a long time, which may decrease the resource efficiency. Furthermore, the Measurement Report message may be large in size because the message includes the measurement results of all cells measured by the UE 100. The third operation pattern is an operation pattern that enables the problem of the conventional conditional handover to be solved by the UE 100 evaluating the possibility of the handover using the model inference.

In the third operation pattern, in response to detection of an increase in the possibility of the handover, a first notification indicating an increase in the possibility of the handover is transmitted to the gNB 200 (source cell). This allows, for example, the gNB 200 (source cell) to perform the handover preparation based on the first notification. Here, the increase in the possibility of the handover may mean that the probability of the handover changes from 0% to a value of 1% or more (i.e., the possibility of the handover occurs). The increase may mean that the probability of the handover exceeds a threshold (which may be a threshold configured by the gNB 200). The increase may mean that an increase amount of the probability of the handover is equal to or greater than a predetermined amount.

In the third operation pattern, in response to detection of a decrease in the possibility of the handover, the UE 100 may transmit a second notification indicating a decrease in the possibility of the handover to the gNB 200 (source cell). This allows, for example, the gNB 200 (source cell) to cancel the handover preparation based on the second notification. Here, the decrease in the possibility of the handover may mean that the probability of the handover changes from a value of 1% or more to 0% (i.e., there is no possibility of the handover). The decrease may mean that the probability of the handover falls below a threshold (which may be a threshold configured by the gNB 200). The decrease may mean that a decrease amount of the probability of the handover is equal to or greater than a predetermined amount.

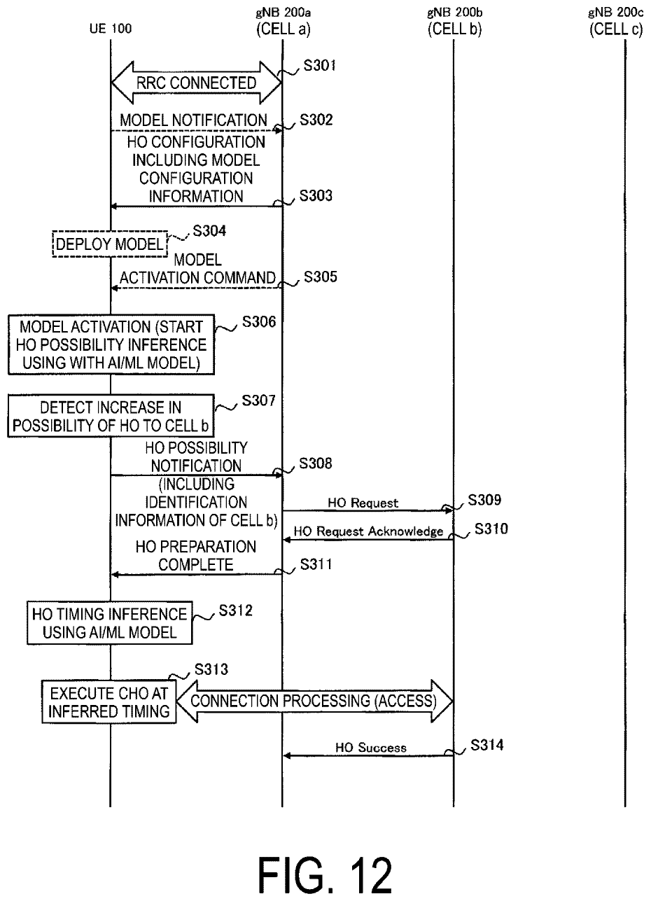

FIG. 12 is a diagram illustrating an example of the third operation pattern of the mobile communication system 1 according to the embodiment.

In step S301, the UE 100 is in the RRC connected state with the cell a managed by the gNB 200a being the serving cell.

In step S302, the UE 100 may transmit, to the cell a (gNB 200a), a model notification including the identification information (function ID or model ID) of the AI/ML model that the UE 100 has. The UE 100 may transmit, to the cell a (gNB 200a), a UE Capability Information message, which is a type of RRC message indicating capabilities of the UE 100 and including the model notification. The model notification may be registered and held in the gNB 200 (network 5) as part of a UE context.

In step S303, the gNB 200a configures a model inference-based conditional handover for the UE 100. Specifically, the gNB 200a transmits an RRC Reconfiguration message including the model configuration information to the UE 100. The UE 100 receives the RRC Reconfiguration message. After receiving the RRC Reconfiguration message, the UE 100 may transmit an RRC Reconfiguration Complete message to the gNB 200a.

In the third operation pattern, the model configuration information includes the model configuration information for configuring (designating) an AI/ML model to be used to evaluate a handover execution trigger. The model configuration information includes at least one piece of information of the following 1) to 6).
1) Identification information of the AI/ML model to be used to evaluate the possibility of the handover and evaluate the handover execution trigger (model ID or function ID):
   The model ID may be an identifier uniquely identifying the AI/ML model to be used to evaluated the possibility of the handover and evaluate the handover execution trigger. The function ID may be, for example, an identifier indicating a function of evaluating the possibility of the handover and evaluating the handover execution trigger (or a function such as “model inference based handover”). Note that the evaluation of the possibility of the handover and the evaluation of the handover execution trigger may be performed using one AI/ML model, or may be performed using two respective different AI/ML models. In this case, when two different AI/ML models are used, the model configuration information may include two pieces of AI/ML model identification information. Note that the UE 100, when not having the AI/ML model designated by the gNB 200a, may transmit a model provision request to the gNB 200a. The model provision request may include the identification information (model ID or function ID) of the AI/ML model requested to be provided. The gNB 200a may respond to the request and provide the AI/ML model to the UE 100.
2) AI/ML model:
   The gNB 200 may provide the AI/ML model itself to be used to evaluate the possibility of the handover and evaluate the handover execution trigger to the UE 100. When the evaluation of the possibility of the handover and the evaluation of the handover execution trigger are performed using two respective different AI/ML models, the model configuration information may include the two different AI/ML models.
3) Information indicating the “model inference” as event type information in the execution condition for handover (triggering condition):
   Information indicating the “model inference” (which may be a model ID) may be included as the “CHO execution condition” for configuring the execution condition for handover.
4) Restriction information for trigger evaluation:
   The restriction information may include information (e.g., one or more thresholds) indicating a radio quality range in which triggering of a conditional handover is permitted on a model inference basis. The restriction information may include a radio quality threshold that forcibly triggers a conditional handover.
5) Model activation information:
   The model activation information is configuration information indicating whether to activate the AI/ML model (model inference) at the time of configuring the AI/ML model. After the AI/ML model is configured, the AI/ML model (model inference) may be activated by the gNB 200 transmitting a model activation command to the UE 100.
6) Information of frequency to be measured (frequency of handover destination candidate):
   The model configuration information may include information for configuring a frequency which the UE 100 should measure. Alternatively, the UE 100 may receive the SIB4 including information for inter-frequency cell reselection from the gNB 200a, and determine a frequency which the UE 100 should measure, based on frequency information included in the SIB4.

Note that in the third operation pattern, the gNB 200a does not need to configure the measurement configuration for the measurement report for the UE 100. For example, the gNB 200a may configure the configuration of step S303 for the UE 100 without the measurement configuration for the UE 100 at the stage where the UE 100 connects to the gNB 200a.

In step S304, the UE 100 may deploy the AI/ML model in accordance with the model configuration information of step S303. Specifically, the UE 100 may deploy the AI/ML model in an AI processor of the UE 100 to prepare for execution of the AI/ML model.

In step S305, the gNB 200 may transmit a model activation command to the UE 100. The model activation command may include the identification information (model ID or function ID) of the AI/ML model to be activated. The model activation command may be, for example, an RRC message. The model activation command may be, for example, a MAC CE.

In step S306, the UE 100 activates the AI/ML model and starts evaluating the HO possibility (HO probability) for each candidate cell. Note that, when the model activation information indicates that the AI/ML model (model inference) is activated at the time of configuring the AI/ML model, the UE 100 may activate the AI/ML model (model inference) at the time of configuring the AI/ML model (step S303) or at the time of deploying the AI/ML model (step S304).

In step S307, the UE 100 estimates (determines) the candidate cell and the possibility of the handover to the candidate cell using the model inference by the AI/ML model. Here, the UE 100 determines the cell b as a candidate cell and determines that the possibility (probability) of the handover to the cell b has increased. For example, the UE 100 may detect that the probability of the handover to the cell b changes from 0% to a value 1% or more (that is, the possibility of the handover occurs), that the probability of the handover to the cell b exceeds a threshold (which may be a threshold configured by the gNB 200), or that the increase amount of the probability of the handover to the cell b is equal to or greater than a predetermined amount.

In step S308, the UE 100 transmits a first notification (HO possibility notification) indicating that the possibility (probability) of the handover to the cell b has increased to the cell a (gNB 200a). The gNB 200a receives the first notification (HO possibility notification). The UE 100 may transmit a UE Assistance Information message including the first notification (HO possibility notification), the UE Assistance Information message being a type of RRC message. The UE 100 may transmit a new message for AI/ML including the first notification (HO possibility notification). The first notification (HO possibility notification) includes at least one piece of information of the following 1) to 3).
1) Cell ID of the candidate cell (target cell):
   In the illustrated example, the UE 100 may include the cell ID of the cell b in the first notification (HO possibility notification).
2) Estimated handover probability:
   In the illustrated example, the UE 100 may include the probability of performing the handover to the cell b in the first notification (HO possibility notification).
3) Estimated execution timing of the handover
   In the illustrated example, the UE 100 may include information indicating an estimated timing of performing the handover to the cell b in the first notification (HO possibility notification). In this case, the gNB 200a may suspend the request for resource preparation of the cell b (step S309) until the timing approaches.

In step S309, the gNB 200a transmits a HO Request message for requesting a conditional handover of the UE 100 to the gNB 200b managing the cell b. Here, the gNB 200a may transmit the HO Request message including the information included in the notification of the step S308.

In step S310, the gNB 200b transmits a HO Request Acknowledge message to the gNB 200a in response to receiving the HO Request message. The HO Request Acknowledge message includes configuration information (RRC configuration information) required for the UE 100 to access the cell b. The gNB 200b may transmit the HO Request Acknowledge message including information indicating a time (time limit) for saving the resources for the UE 100. The time (time limit) defines a time period during which the UE 100 can access the cell b.

In step S311, in response to receiving the HO Request Acknowledge message, the gNB 200b transmits, to the UE 100, a HO preparation complete message including the RRC configuration information in the HO Request Acknowledge message and indicating that the handover preparation (Ack of the target gNB 200) is completed. The UE 100 receives the HO preparation complete message. The HO preparation complete message may be an RRC Reconfiguration message. In this case, after receiving the RRC Reconfiguration message, the UE 100 may transmit an RRC Reconfiguration Complete message to the gNB 200a.

The HO preparation complete message may include information indicating a time (time limit) for the gNB 200b (cell b), which is the target gNB, to save the resources. Upon receiving the HO preparation complete message, the UE 100 may start a timer (a timer associated with the cell b) in which that time is set. The UE 100 may stop the timer when accessing the cell b which is the target cell. When the timer expires, the UE 100 may determine that the access to the cell b is not available.

In step S312, the UE 100 starts evaluating the optimal HO execution timing (CHO trigger) for the cell b which is the target cell. For example, the UE 100 inputs at least the measurement result of the radio quality of each cell to the AI/ML model, and determines the execution timing of the handover (trigger) using the model inference by the AI/ML model. The AI/ML model may output the optimal HO execution timing (access timing) for the target cell (cell b). Note that the UE 100 may continue to evaluate the possibility of the handover in the step S306. The UE 100 may stop the evaluation.

In step S313, the UE 100 executes a handover to the target cell (cell b) at the timing determined at step S312 and starts accessing the target cell. The UE 100 may initiate the random access procedure for the cell b at that timing, and transmit the random access preamble to the cell b. Alternatively, when the random access procedure is omitted, the UE 100 may transmit an RRC Reconfiguration Complete message to the cell b at the optimal timing. When such connection processing is completed, the UE 100 continues communication with the cell b being a new serving cell.

In step S314, the gNB 200b, which is the target gNB, transmits a HO Success message indicating that the UE 100 has successfully accessed the target cell (cell b) to the gNB 200a, which is the source gNB.

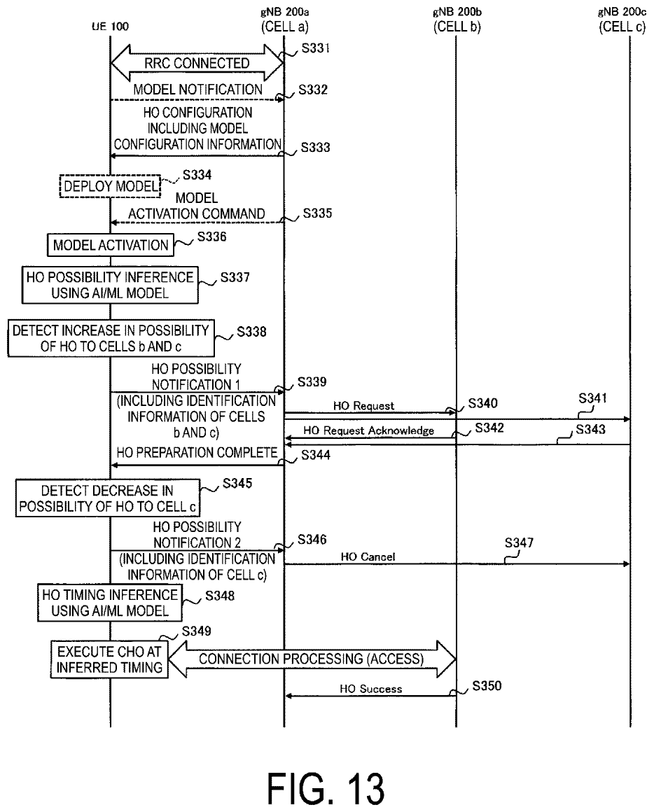

FIG. 13 is a diagram illustrating another example of the third operation pattern of the mobile communication system 1 according to the embodiment. For the operation example of FIG. 13, differences from the operation example of FIG. 12 are mainly described.

The operations in steps S331 to S337 are the same as and/or similar to the operation example of FIG. 12.

In step S338, the UE 100 estimates (determines) the candidate cell and the possibility of the handover to the candidate cell using the model inference by the AI/ML model. Here, the UE 100 determines the cells b and c as candidate cells and determines that the possibilities (probabilities) of the handover to the cells b and d have increased.

In step S339, the UE 100 transmits a first notification (HO possibility notification 1) indicating that the possibilities (probabilities) of the handover to the cells b and c have increased to the cell a (gNB 200a). The gNB 200a receives the first notification (HO possibility notification 1). The first notification (HO possibility notification 1) includes at least one piece of information of the following 1) to 3).
1) Cell ID of the candidate cell (target cell):
   In the illustrated example, the UE 100 may include the cell IDs of the cells b and c in the first notification (HO possibility notification 1).
2) Estimated handover probability:
   In the illustrated example, the UE 100 may include the probability of performing the handover to the cell b and the probability of performing the handover to the cell c in the first notification (HO possibility notification 1).
3) Estimated execution timing of the handover
   In the illustrated example, the UE 100 may include information indicating an estimated timing of performing the handover to the cell b and information indicating an estimated timing of performing the handover to the cell c in the first notification (HO possibility notification 1).

In step S340, the gNB 200a transmits a HO Request message for requesting a conditional handover of the UE 100 to the gNB 200b managing the cell b. The gNB 200a may transmit the HO Request message including the information included in the notification of the step S339.

In step S341, the gNB 200a transmits a HO Request message for requesting a conditional handover of the UE 100 to the gNB 200c managing the cell c. The gNB 200a may transmit the HO Request message including the information included in the notification of the step S339.

In step S342, the gNB 200b transmits a HO Request Acknowledge message to the gNB 200a in response to receiving the HO Request message. The HO Request Acknowledge message includes configuration information (RRC configuration information) required for the UE 100 to access the cell b. The gNB 200b may transmit the HO Request Acknowledge message including information indicating a time (time limit) for saving the resources for the UE 100. The time (time limit) defines a time period during which the UE 100 can access the cell b.

In step S343, the gNB 200c transmits a HO Request Acknowledge message to the gNB 200a in response to receiving the HO Request message. The HO Request Acknowledge message includes configuration information (RRC configuration information) required for the UE 100 to access the cell c. The gNB 200b may transmit the HO Request Acknowledge message including information indicating a time (time limit) for saving the resources for the UE 100. The time (time limit) defines a time period during which the UE 100 can access the cell c.

In step S344, in response to receiving the HO Request Acknowledge messages in steps S342 and S343, the gNB 200b transmits, to the UE 100, a HO preparation complete message including the RRC configuration information in these HO Request Acknowledge messages and indicating that the handover preparation (Ack of the target gNB 200) is completed. The UE 100 receives the HO preparation complete message. The HO preparation complete message may be an RRC Reconfiguration message.

In step S345, the UE 100 estimates (determines) the target cell and the possibility of the handover to the target cell using the model inference by the AI/ML model. Here, the UE 100 determines that the possibility (probability) of the handover to the cell c has decreased. For example, the UE 100 may detect that the probability of the handover to the cell c changes from a value of 1% or more to 0% (i.e., there is no possibility of the handover), that the probability of the handover to the cell c falls below a threshold (which may be a threshold configured by the gNB 200), or that the decrease amount of the probability of the handover to the cell c is equal to or greater than a predetermined amount.

In step S346, the UE 100 transmits a second notification (HO possibility notification 2) indicating that the possibility (probability) of the handover to the cell c has decreased to the cell a (gNB 200a). The gNB 200a receives the second notification (HO possibility notification 2). The UE 100 may transmit a UE Assistance Information message including the second notification (HO possibility notification 2), the UE Assistance Information message being a type of RRC message. The UE 100 may transmit a new message for AI/ML including the second notification (HO possibility notification 2). The second notification (HO possibility notification 2) includes at least one piece of information of the following 1) and 2).
1) Cell ID of the candidate cell (target cell) the probability of the handover to which has decreased:
   In the illustrated example, the UE 100 may include the cell ID of the cell c in the second notification (HO possibility notification 2).
2) Estimated handover probability:
   In the illustrated example, the UE 100 may include the probability of performing the handover to the cell c in the second notification (HO possibility notification 2).

In step S347, the gNB 200a transmits a HO Cancel message indicating cancellation of the conditional handover of the UE 100 to the gNB 200c managing the cell c. This allows the gNB 200c to release the resources prepared (reserved) for the UE 100.

In step S348, the UE 100 evaluates the optimal HO execution timing (CHO trigger) for the cell b which is the target cell.

In step S349, the UE 100 executes a handover to the target cell (cell b) at the timing determined at step S348 and starts accessing the target cell. When such connection processing is completed, the UE 100 continues communication with the cell b being a new serving cell.

In step S350, the gNB 200b, which is the target gNB, transmits a HO Success message indicating that the UE 100 has successfully accessed the target cell (cell b) to the gNB 200a, which is the source gNB.

### (3.3.4) Fourth Operation Pattern of Mobile Communication System

The fourth operation pattern is an operation pattern that can be implemented in combination with the first to third operation patterns described above.

In the fourth operation pattern, after attempting a handover (access to the target cell), the UE 100 stores the log information regarding whether the handover was successful. The log information is the failure log information (handover failure report) indicating that the handover was failed or the success log information (success handover report) indicating that the handover was succeeded. The log information includes the model inference information regarding whether the model inference was applied to the handover. The model inference information may include the identification information (function ID or model ID) of the AI/ML model that was used for the model inference. The UE 100 transmits the log information to the gNB 200.

This allows the gNB 200 (network 5) to grasp whether the handover in the UE 100 is successful based on the log information, and grasp whether the model inference was applied to the handover (and/or which AI/ML model is applied). Therefore, the network 5 can appropriately perform optimization of the network 5 (and/or optimization of the AI/ML model) for increasing the handover success rate.

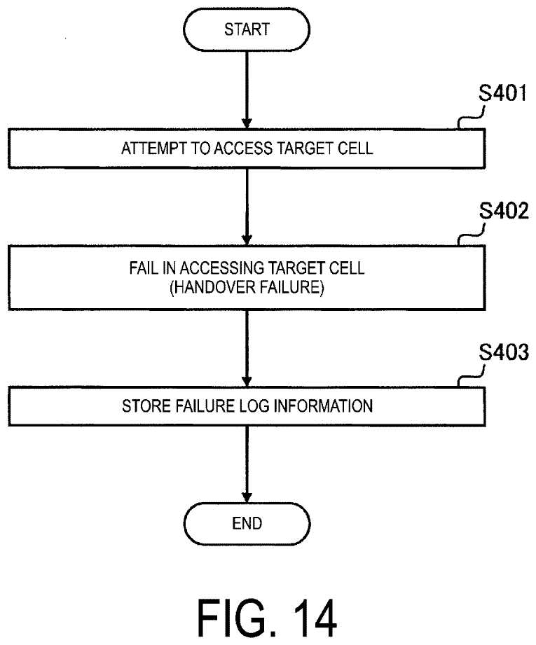

FIG. 14 is a flowchart illustrating an operation example of the UE 100 upon failing in a handover in the fourth operation pattern of the mobile communication system 1 according to the embodiment. Assume that the AI/ML model (model inference) of any one of the first to third operation patterns is configured for the UE 100.

In step S401, the UE 100 identifies the target cell and attempts to access the target cell.

In step S402, the UE 100 fails in accessing the target cell. For example, the UE 100, when failing in the random access procedure to the target cell, determines that the UE 100 fails in accessing the target cell.

In step S403, the UE 100 stores the failure log information. The failure log information is also referred to as handover failure information. The failure log information may form part of a radio link failure (RLF) report. The failure log information may include information indicating a handover failure, a cell ID of a source cell, a cell ID of a target cell (i.e., a handover failure cell), and information indicating a type of failed handover. In the fourth operation pattern, the failure log information includes at least one piece of information of the following 1) to 4).
1) Identification information of the AI/ML model (model ID or function ID) having been used for the model inference:
   The UE 100 may store the failure log information including the identification information of the AI/ML model having been used for the model inference.
2) Information indicating “model inference-based handover” as the type of failed handover:
   The UE 100 may store the failure log information including information indicating “model inference-based handover” as the type of failed handover (lastHO type).
3) Information of the cell ID and frequency of the target cell:
   The UE 100 may store the failure log information including information of the cell ID of the target cell determined by the model inference and the frequency of the target cell.
4) Information for the model inference results:
   The UE 100 may store the failure log information including at least one piece of information of information indicating a time from when estimating the HO possibility (model inference) until when failing in accessing the target cell, information indicating the execution timing of the handover determined by the model inference, and information indicating the possibility of the handover determined by the model inference.

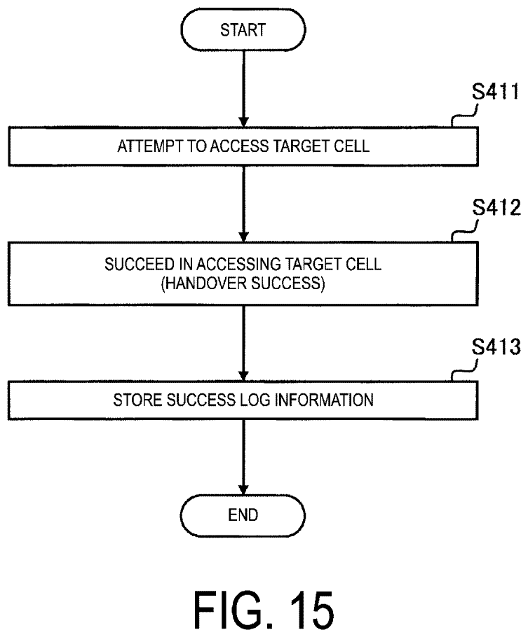

FIG. 15 is a flowchart illustrating an operation example of the UE 100 upon succeeding in a handover in the fourth operation pattern of the mobile communication system 1 according to the embodiment. Assume that the AI/ML model (model inference) of any one of the first to third operation patterns is configured for the UE 100.

In step S411, the UE 100 identifies the target cell and attempts to access the target cell.

In step S412, the UE 100 succeeds in accessing the target cell. For example, the UE 100, when succeeding in the random access procedure to the target cell, determines that the UE 100 succeeds in accessing the target cell.

In step S413, the UE 100 stores the success log information. The success log information is also referred to as a success handover report (SuccessHO Report). The success log information may include a cell ID of a source cell and a cell ID of a target cell. In the fourth operation pattern, the success log information includes at least one piece of information of the following 1) to 4).
1) Identification information of the AI/ML model (model ID or function ID) having been used for the model inference:
   The UE 100 may store the success log information including the identification information of the AI/ML model having been used for the model inference.
2) Information indicating “model inference-based handover” as the type of succeeded handover:
   The UE 100 may store the success log information including information indicating “model inference-based handover” as the type of succeeded handover.
3) Information of the cell ID and frequency of the target cell:
   The UE 100 may store the success log information including information of the cell ID of the target cell determined by the model inference and the frequency of the target cell.
4) Information for the model inference results:
   The UE 100 may store the success log information including at least one piece of information of information indicating a time from when estimating the HO possibility (model inference) until when succeeding in accessing the target cell, information indicating the execution timing of the handover determined by the model inference, and information indicating the possibility of the handover determined by the model inference.

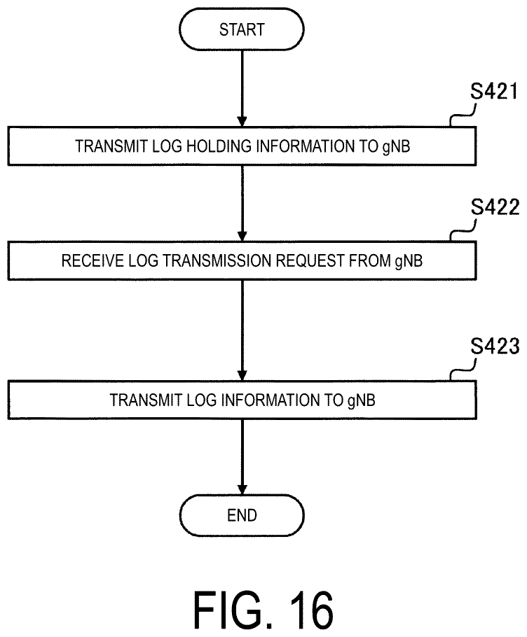

FIG. 16 is a flowchart illustrating an example of a log transmission operation of the UE 100 in the fourth operation pattern of the mobile communication system 1 according to the embodiment.

In step S421, the UE 100 transmits log holding information (Availability Indication) indicating that the UE 100 holds the log information to the gNB 200. The UE 100, when holding the failure log information, may transmit first log holding information indicating that the UE 100 holds the failure log information to the gNB 200. The UE 100, when holding the success log information, may transmit second log holding information indicating that the UE 100 holds the success log information to the gNB 200. Note that the UE 100 may transmit the log holding information to the gNB 200 at the time of RRC connection setup, RRC connection resumption, and the like.

In step S422, the UE 100 receives from the gNB 200 a request message (UE Information Request message) for requesting transmission of the log information. The request message may include first request information for requesting transmission of the failure log information and/or second request information for requesting transmission of the success log information.

In step S423, in response to receiving the request message, the UE 100 transmits a response message (UE Information Response message) including the log information to the gNB 200.

### (4) Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an Integrated Access and Backhaul (IAB) node. The base station may be a distributed unit (DU) of the IAB node. The user equipment (terminal apparatus) may be a relay node such as an IAB node or a Mobile Termination (MT) of the IAB node.

In other words, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each piece of the processing performed by the communication apparatus (e.g., UE 100 or gNB 200) may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

As used in this disclosure, the terms “based on” and “depending on” do not mean “based only on” or “depending only on”, unless otherwise specified. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplementary Notes

Features relating to the embodiments described above are described below as supplementary notes.

### Supplementary Note 1

A communication method performed by a user equipment in a mobile communication system, the communication method including:
transmitting, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

### Supplementary Note 2

The communication method according to Supplementary Note 1, wherein
the notification includes information indicating an inference result of the model inference and identification information of the candidate cell, and
the network node is a network node configured to manage the source cell.

### Supplementary Note 3

The communication method according to Supplementary Note 2, further including
evaluating, by the user equipment, the possibility using the model inference, wherein
the step of transmitting includes a step of transmitting a first notification indicating an increase in the possibility to the network node in response to detecting the increase in the possibility.

### Supplementary Note 4

The communication method according to Supplementary Note 2 or 3, wherein the step of transmitting includes a step of transmitting a second notification indicating a decrease in the possibility to the network node in response to detecting the decrease in the possibility.

### Supplementary Note 5

The communication method according to any one of Supplementary Notes 1 to 4, further including:
attempting the cell switching; and
storing log information regarding whether the cell switching is successful, wherein
the log information includes model inference information regarding whether the model inference is applied to the cell switching, and
the step of transmitting includes a step of transmitting the notification including the log information to the network node.

### Supplementary Note 6

The communication method according to Supplementary Note 5, wherein the model inference information includes identification information for identifying the AI/ML model used for the model inference.

### Supplementary Note 7

The communication method according to Supplementary Note 5 or 6, wherein the model inference information includes information indicating that the model inference has been applied to the cell switching.

### Supplementary Note 8

The communication method according to any one of Supplementary Notes 5 to 7, wherein the model inference information includes information indicating a result of the model inference.

### Supplementary Note 9

The communication method according to any one of Supplementary Notes 5 to 8, wherein the log information is failure log information indicating that the cell switching is unsuccessful.

### Supplementary Note 10

The communication method according to any one of Supplementary Notes 5 to 8, wherein the log information is success log information indicating that the cell switching is successful.

### Supplementary Note 11

A user equipment used in a mobile communication system, the user equipment including
a transmitter configured to transmit, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

### Supplementary Note 12

A network node used in a mobile communication system, the network node including a receiver configured to receive, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference from the user equipment.

### REFERENCE SIGNS

1: Mobile communication system
5: Network
10: RAN (NG-RAN)
20: CN (5GC)
100: UE
110: Receiver
120: Transmitter
130: Controller
200: gNB
210: Transmitter
220: Receiver
230: Controller
240: Backhaul communicator
A1: Data collector
A2: Model training unit
A3: Model inference unit
A4: Data processor

1. A communication method performed by a user equipment in a mobile communication system, the communication method comprising:
transmitting, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

2. The communication method according to claim 1, wherein
the notification includes information indicating an inference result of the model inference and identification information of the candidate cell, and
the network node is a network node configured to manage the source cell.

3. The communication method according to claim 2, further comprising
evaluating, by the user equipment, the possibility using the model inference, wherein
the transmitting comprises transmitting a first notification indicating an increase in the possibility to the network node in response to detecting the increase in the possibility.

4. The communication method according to claim 2, wherein the transmitting comprises transmitting a second notification indicating a decrease in the possibility to the network node in response to detecting the decrease in the possibility.

5. The communication method according to claim 1, further comprising:
attempting the cell switching; and
storing log information regarding whether the cell switching is successful, wherein
the log information includes model inference information regarding whether the model inference is applied to the cell switching, and
the transmitting comprises transmitting the notification including the log information to the network node.

6. The communication method according to claim 5, wherein the model inference information includes identification information for identifying the AI/ML model used for the model inference.

7. The communication method according to claim 5, wherein the model inference information includes information indicating that the model inference has been applied to the cell switching.

8. The communication method according to claim 5, wherein the model inference information includes information indicating a result of the model inference.

9. The communication method according to claim 5, wherein the log information is failure log information indicating that the cell switching is unsuccessful.

10. The communication method according to claim 5, wherein the log information is success log information indicating that the cell switching is successful.

11. A user equipment used in a mobile communication system, the user equipment comprising
a transmitter configured to transmit, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference to a network node.

12. A network node used in a mobile communication system, the network node comprising
a receiver configured to receive, based on an evaluation of a possibility of cell switching from a source cell to a candidate cell and/or an execution timing of the cell switching that is performed by the user equipment using a model inference by an artificial intelligence or machine learning (AI/ML) model, a notification about the model inference from the user equipment.
